(19) United States
(12) Patent Application Publication
(10) Pub. No.: US 2023/0016013 A1
(43) Pub. Date: Jan. 19, 2023

(54) MASSAGE TOOL

(71) Applicant: Ian Devalal, New Palestine, IN (US)

(72) Inventor: Ian Devalal, New Palestine, IN (US)

(21) Appl. No.: 17/846,257

(22) Filed: Jun. 22, 2022

Related U.S. Application Data
(60) Provisional application No. 63/222,507, filed on Jul. 16, 2021.

(51) Int. Cl. A61H 7/00

(52) U.S. Cl. CPC A61H 7/003; A61H 2201/0153; A61H 2201/169

(57) ABSTRACT

A massage tool, including a generally cylindrical grip portion, a generally hemispherical massage head portion, wherein the generally hemispherical massage head portion defines an edge portion and a generally flat bottom portion, and an extension member extending between and connected to the generally hemispherical massage head portion and the generally cylindrical grip portion.

### CROSS-REFERENCE TO RELATED APPLICATIONS

This patent application claims priority to U.S. Provisional Patent Application Ser. No. 63/222,507, filed on Jul. 16, 2021.

### TECHNICAL FIELD

The present novel technology relates to the field of physical rehabilitation, and, more particularly, to a massage tool.

### BACKGROUND

Massage is a technique not only for relaxing the individual, but also for physical therapy and rehabilitation of damaged muscle tissue. Often, muscle has to be kneaded, pulled, and scraped by the masseuse or therapist, and quite frequently the thumbs take the brunt of this work. Repeated muscle manipulation can take its toll on the thumbs of the therapist, leading to injury and the inability to properly focus and control the thumbs during extended treatment and use thereof, which can result in injury to both the therapist and the patient.

Thus, there is a need for a compact tool that can mimic the utility of the thumbs in a massage session while avoiding injury to the therapist and allowing continued control and efficacy to the patient. The present novel technology addresses this need.

### BRIEF DESCRIPTION OF THE DRAWINGS

FIGS. 1-3 are views of a massage tool according to a first embodiment of the present novel technology.

FIG. 4 is a perspective view of a second embodiment of the present novel technology.

### DETAILED DESCRIPTION

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alteration and further modifications in the illustrated elongated member and such further applications of the principles of the novel technology as illustrated therein being contemplated as would normally occur to one skilled in the art to which the novel technology relates.

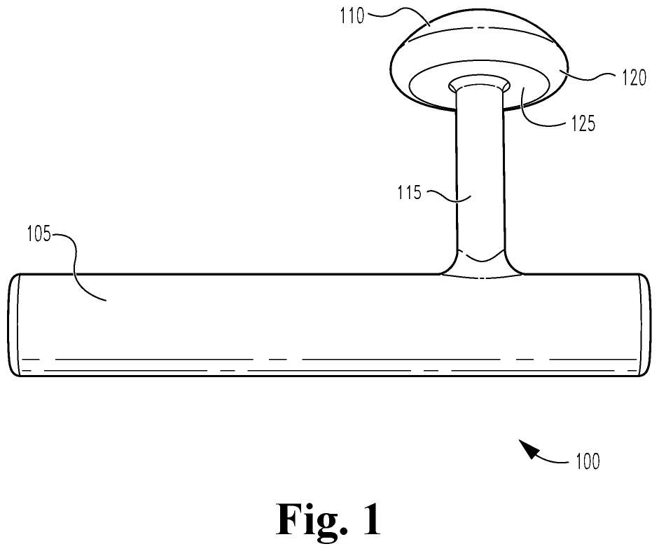

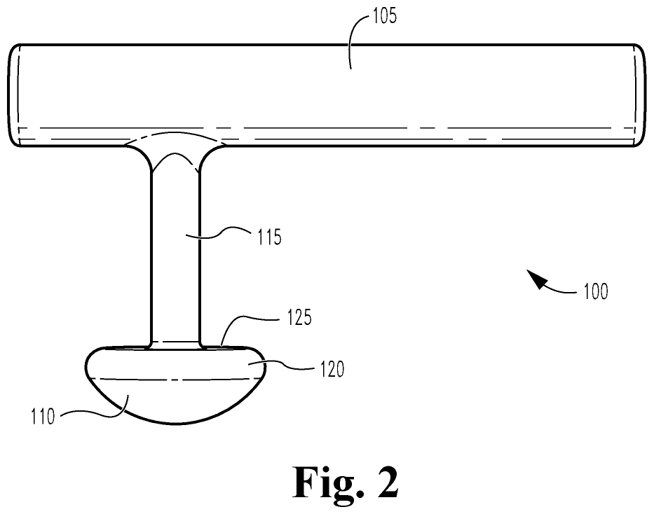

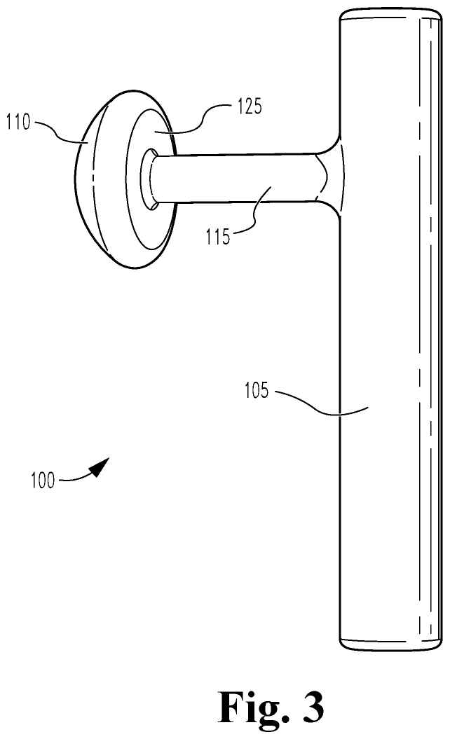

FIGS. 1-3 illustrate a first embodiment handheld muscle manipulation tool 100. The tool 100 is typically made of a structural material, more typically stainless steel, but may be made of any convenient, and typically metallic, structural material. When engaged by a physical therapist, the tool 100 is used to do muscle work therapy, such as breaking up scar tissue. The tool 100 is useful for the break-up of myofascial adhesions, which is the connected tissue around the muscle.

Tool 100 includes a generally cylindrica grip portion 105, a massage head portion 110, and an extension portion 115 disposed between and connected to the grip and head portions 105, 110. The head portion 110 is typically rounded, and more typically hemispherical in shape and having a relatively well-defined edge portion 120 defining a generally flat portion 125 to which the extension portion 115 is centered and connected.

The rounded head 110 and edge 120 portions can be used to manipulate and relax muscle tissue and to push out metabolic waste, such as trapped lactic acid or the like, saving wear on the thumbs of the therapist.

In operation, the chiropractor or therapist grips the tool 100 along the elongated cylindrical body member 105 and urges the rounded hemispherical head 110 into the muscle belly, a predetermined trigger point, or the like, to work the muscle as desired. The rounded head 110 is smoothed out for moving and manipulating the muscle or holding it in one place. The bottom edge 120 of the hemispherical portion 110 may be used to scrape and pull the muscle.

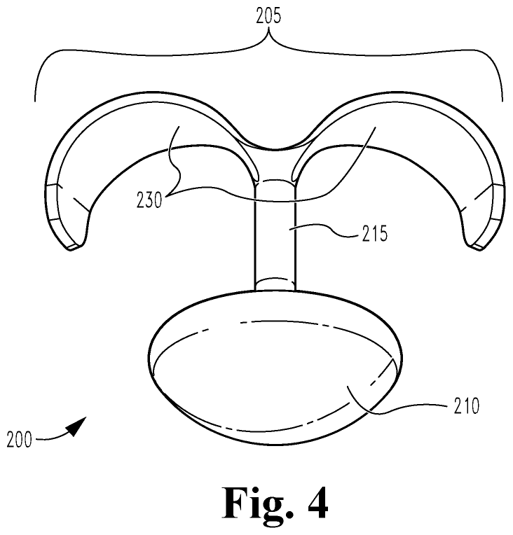

A second embodiment tool 200 is illustrated in FIG. 4, and includes a head portion 210 and extension portion 215 similar to those of the previous embodiment, but having a grip portion 205 defining a pair of oppositely disposed curved members 230 intersecting at, and connected to, extension member 215. Tool 100 is typically made of a structural material, more typically stainless steel, but may be made of any convenient structural material.

In operation, a massage therapist or other user may use the tool 100, 200 by gripping the grip portion 105, 205 and then engaging a patient with a massage head portion 110, 210. The user may manipulate a muscle within the patient with the massage head 110, 210, and may manipulate the muscle with the hemispherical head portion, the circumferential edge portion, or both.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

I claim:

1. A massage tool, comprising:
a generally cylindrical grip portion;
a generally hemispherical massage head portion, wherein the generally hemispherical massage head portion defines an edge portion and a generally flat bottom portion; and
an extension member extending between and connected to the generally hemispherical massage head portion and the generally cylindrical grip portion.

2. The massage tool of claim 1 wherein the massage tool is made of a metallic structural material.

3. The massage tool of claim 2 wherein the massage tool is made of stainless steel.

4. A metal massage tool, comprising:
a grip portion;
a generally hemispherical massage head portion, wherein the generally hemispherical massage head portion defines an edge portion and a generally flat bottom portion; and
an extension member extending between and connected to the generally hemispherical massage head portion and the generally cylindrical grip portion.

5. The metal massage tool of claim 4 wherein the massage tool is made of a metallic structural material.

6. The metal massage tool of claim 5 wherein the massage tool is made of stainless steel.

7. The metal massage tool of claim 4 wherein the grip portion is generally cylindrical.

8. The metal massage tool of claim 4 wherein the grip portion is a pair of oppositely disposed curved members connected to the extension member.

9. The metal massage tool of claim 4 wherein the metal massage tool is made of stainless steel.

10. A method of massaging, comprising:
a) gripping the grip portion of a stainless steel massage tool;
b) engaging a patient with a massage head portion of the stainless steel massage tool, wherein the grip portion and the massage head portion are connected by an elongated intermediate portion;
c) manipulating a muscle within the patient with the massage head;
wherein the massage head is hemispherical and defines a circular fat bottom portion having a circumferential edge portion.

11. The method of claim 10 and further comprising:
d) manipulating the muscle with the circumferential edge portion.
